(19) United States
(12) Patent Application Publication
(10) Pub. No.: US 2004/0181670 A1
(43) Pub. Date: Sep. 16, 2004

(54) System and method for disguising data

(76) Inventors: Carl Thune, Princeton, NJ (US); Laura Gashlin, Parsippany, NJ (US); Barbara Howard, North Salem, NY (US); Barbara Chin, Mendham, NJ (US); Robert Chin, Mendham, NJ (US)

Correspondence Address: Wolff & Samson, P.C., One Boland Drive, West Orange, NJ, 07052, US

(21) Appl. No.: 10/385,199

(22) Filed: Mar. 10, 2003

(51) Int. Cl. H04L 9/00

(52) U.S. Cl. 713/176; 713/200

(57) ABSTRACT

A system and method for disguising and de-identifying data is provided. Records are extracted from an input data set containing confidential information (e.g., a production database). One or more data transformation algorithms for disguising specific types of data, including first names, last names, company names, telephone numbers, addresses, social security numbers, and e-mail addresses, in addition to generic data, are applied to the records to disguise or “scrub” confidential information therefrom. The transformation algorithms retrieve substitute information from one or more lookup tables, or generate substitute information using in-memory manipulation rules, and produce output records containing the substitute information. The output records are structurally similar to the input records, contain no confidential information, and are stored in an output data set that can be utilized in less-secure (e.g., non-production) environments. Optionally, transformation keys can be provided for increasing confidentiality and improving transformation effectiveness. A configuration tool allows users of various roles to define, approve, and implement data transformation rules, parameters, and processes.

### BACKGROUND OF THE INVENTION

1. Field of the Invention

The present invention relates to a system and method for disguising and de-identifying data. More specifically, the present invention relates to a system and method for disguising data from one or more production environments for use in non-production environments, wherein the disguised data is structurally similar to the production data, but contains no private or confidential information.

2. Related Art

Corporate production files and databases often contain confidential information. For example, large production repositories existing on enterprise servers often contain personal information, including client names, addresses, telephone numbers, social security numbers, credit card numbers, incomes, and other similar types of information. Often, this information is provided to the corporate entity by its customers and the customers expect that the information will be maintained in confidence by the entity. Further, there may be an obligation imposed on the entity by law, requiring that the information be kept in confidence and not disseminated. Thus, the protection of confidential information is becoming increasingly important to corporate entities.

In contrast with the need to keep information about clients, employees, and other individuals confidential, there is a significant need for corporate employees and outside consultants to utilize personal information to develop and test software. Similar information is used to support a variety of other functions, including training and problem determination. For example, software developers are often given access to corporate production files and databases to use when developing and testing software modules. These files and databases often contain confidential and private information that must be protected so that it can only be viewed and used by those with a clear need to know. Further, to perform regression testing, software developers and testers cannot merely be provided with artificial or unnatural data; rather, the data must appear reasonable and realistic, and must be in a format compatible with the software modules.

Thus, when protecting confidential information, it is important that developers and quality assurance staff be provided with files and databases that look “real,” credible, and reasonable (e.g., that contain disguised but appropriately formatted Social Security Numbers, disguised first names reflecting a person's gender, disguised addresses that look like “real” addresses and can pass address verification tests, and certain types of invalid values that are routinely handled by an organization's systems). However, there currently is no effective methodology for generating test data having such attributes. Moreover, there presently is no effective system for generating output data from an input data set, wherein the structure of data in the output data set is structurally similar to the data of the input set, but which contains no personal or confidential information. Even further, there presently is no effective system wherein confidential information can be consistently transformed for use in less-secure environments (e.g., where a given input value is consistently transformed to the same output value, even if the input value is stored in different formats that reflect the characteristics of different hardware, operating systems, platforms, file structures, or database management systems).

Additionally, there presently is no effective system whereby equivalent information values found in different files or databases can be consistently transformed to support file or database comparison and matching functions (e.g., to ensure social security number or names found in two or more different files or databases are transformed in the same way so that information from these files or databases can be matched and integrated). Moreover, there currently is no effective system that can preserve the uniqueness of unique identifiers after they are transformed (e.g., to ensure than a specific social security number is always is always disguised by being transformed into a single new value, and that no two social security numbers are ever be disguised by being transformed into the same new social security number).

Accordingly, what would be desirable, but has not yet been provided, is a system and method for disguising data, wherein the disguised data is structurally similar to source data, and contains no confidential or personal information.

### SUMMARY OF THE INVENTION

The present invention relates to a system and method for disguising data. An input data set containing confidential information (e.g., a production database) is provided, and records are extracted therefrom. A plurality of data transformation algorithms are provided for disguising specific types of data, including first names, last names, company names, telephone numbers, addresses, social security numbers, and e-mail addresses, in addition to a generic transformation algorithm for disguising information of any type. A plurality of lookup tables are accessed by the transformation algorithms, and contain substitute information that is structurally similar to the source data, appears reasonable, and contains no confidential or personal information. The transformation algorithms retrieve the substitute information from the lookup tables and produce output records containing the substitute information. Consistent data transformation is achieved, wherein a given value from an input record is transformed to the same value in an output record. Differences in logically-identical input data formats (e.g., “121 Main Street, New York, N.Y. ” versus “121 Main St., NY, N.Y.”) are tolerated, and the same output value is produced. Important attributes of the input data are preserved in the transformed data (e.g., social security and telephone number formatting hyphenation are preserved). Results of transformation can be repeated, wherein a transformation of a specific input string will result in the same output string being produced for all future transformations of that input string. The output records are stored in an output data set that is free of confidential information and can be used in less-secure (e.g., non-production) environments. Optionally, transformation keys can be provided for increasing confidentiality.

In an embodiment of the present invention, a configuration tool is provided for allowing users to define and approve transformation rules and initiate a transformation process. A variety of user roles are provided, including a definer, an application approver, a global approver, and an operator, and permissions can be assigned to each role. The user can specify transformation rules and parameters using the configuration tool. A graphical user interface is provided for allowing the users to access and utilize the configuration tool.

In another embodiment of the present invention, a plurality of pluggable data transformation modules are provided. The behavior of the modules for transforming specific types of input information can be customized for specific applications by defining input parameters in a configuration file. The modules can be integrated with a custom-developed or vendor-provided driver program, as desired by the user. The driver program can be invoked by the configuration tool. The pluggable data transformation modules use the rules specified and approved via the configuration tool.

### BRIEF DESCRIPTION OF THE DRAWINGS

These and other important objects and features of the invention will be apparent from the following Detailed Description of the Invention, taken in connection with the accompanying drawings, in which:

FIG. 1 is a diagram showing the overall system architecture of the present invention.

FIG. 2 is a flowchart showing a generic data transformation algorithm according to the present invention.

FIG. 3A is a flowchart showing a specific data transformation algorithm according to the present invention for disguising a first name.

FIG. 3B is a flowchart showing a specific data transformation algorithm according to the present invention for disguising a last name.

FIG. 3C is a flowchart showing a specific data transformation algorithm according to the present invention for disguising a company name.

FIG. 3D is a flowchart showing a specific data transformation algorithm according to the present invention for disguising a telephone number.

FIG. 3E is a flowchart showing a specific data transformation algorithm according to the present invention for disguising an address.

FIG. 3F is a flowchart showing a specific data transformation algorithm according to the present invention for disguising a social security number.

FIG. 3G is a flowchart showing a specific data transformation algorithm according to the present invention for disguising an e-mail address.

FIG. 4A is a flowchart showing processing logic of the data privatization process of the present invention.

FIG. 4B is a flowchart showing processing logic of the configuration tool of the present invention.

FIGS. 5A-5E are screenshots showing the configuration tool of the present invention.

### DETAILED DESCRIPTION OF THE INVENTION

The present invention relates to a system and method for disguising data. Data from an input source and containing confidential information, such as an enterprise database in a production environment, is disguised (scrubbed) by one or more data transformation algorithms, and stored in an output data set for use in a less-secure environment (e.g., for use by software developers in non-production environments). The transformed data appears structurally similar to the input data, but contains no personal or confidential information. Important attributes of the input data, such as formatting and punctuation, are preserved in the output data set. Transformation occurs consistently, such that during successive transformations, a given input data value will be transformed to the same output data value. Differences in input data formats are tolerated. A configuration tool allows users having various roles to interact with the system, define and approve transformation rules, and initiate a transformation process. Input values are consistently transformed into output values, such that a given input value is always transformed to the same output value. Optional transformation keys are provided for enhancing confidentiality. A plurality of pluggable transformation modules can be provided, wherein a custom-developed or vendor-provided driver program invokes the modules that are controlled by the aforementioned transformation rules.

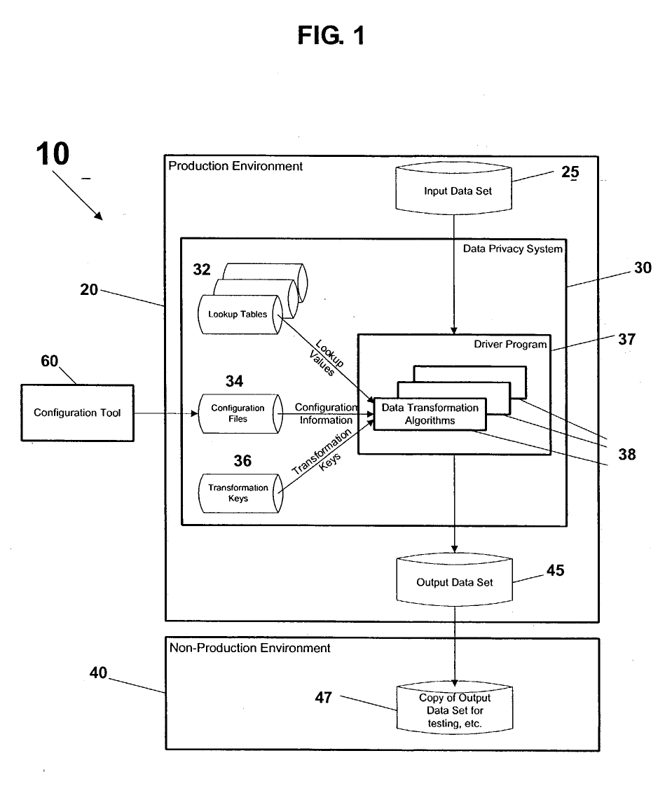

FIG. 1 is a diagram showing the overall system architecture of the present invention, indicated generally at 10. The present invention can be embodied as a data transformation or privacy system 30 executing in a secure production environment 20 that operates on an input data set 25, also extant in the production environment 20. The input data set 25 can be, for example, a corporate client database containing confidential information. The production environment 20 can be any secure environment operating within a corporate enterprise. The data transformation system 30 extracts records from the input data set 25, transforms or “scrubs” same to remove any confidential information while preserving record formats and structure, and outputs same to an output data set 45. A driver program 37 extracts records from the input data set 25 and invokes the appropriate data transformation algorithms 38 based upon the type of information to be disguised. The data transformation algorithms 38 process input values and produce output values through in-memory algorithms and/or by using information from lookup tables 32 and, optionally, transformation keys 36. The output data set 45 can be copied into a secondary output data set 47, for use in a production or non-production environment 40. Such an environment may be, for example, a less-secure software development and testing environment. Of course, the data transformation system 30 can be implemented between any input and output data sets in any conceivable environments.

The data transformation system 30 comprises a plurality of components, including lookup tables 32, configuration files 34, optional transformation keys 36, a driver program 37, and data transformation algorithms 38, that operate together to achieve the functionality and services of the present invention. The driver program 37 reads records from the input data set 25, invokes the necessary data transformation algorithms 38, and writes records to the output data set 45. The data transformation algorithms 38 receive input values from the driver program 37, process same to remove (“scrub”) confidential information therefrom, and return output values to the driver program 37 having no confidential information present. The data transformation algorithms 38 manipulate input values in memory, and/or retrieve substitute information from the lookup tables 32 to provide disguised information that is used to replace confidential information. The configuration files 34 control the data transformation algorithms 38, allowing previously-defined transformation rules to be applied. Optionally, transformation keys 36 can be provided and can be used by the data transformation algorithms 38 to provide an added level of confidentiality and irreversibility to the transformation process.

The data transformation algorithms 38 of the present invention can operate with the driver program 37 in a “pluggable” configuration, wherein any desired transformation algorithm can be dynamically incorporated for use with the driver program 37 without requiring the driver program 37 to be terminated, re-compiled, or otherwise altered. Additional transformation algorithms can be plugged into and used with the driver program 37 as necessary and as same are developed. Further, the driver program 37 could be replaced with any commercially-available or custom-developed utility, such as the MOVE utility manufactured by PRINCETON SOFTECH.

A configuration tool 60 allows a user to interact with and control the data transformation system 30 and the data transformation processes of the present invention. In an embodiment of the present invention, the configuration tool 60 is a web-based application that provides a user interface for allowing the user to define transformation rules and parameters, review and approve same, and initiate one or more transformation processes. However, the configuration tool 60 could be embodied in any type of program, such as a “fat client” program or a standalone program. The rules and parameters are stored in the configuration files 34 of the data transformation system 30, and are accessed by the data transformation algorithms 38. Additionally, the configuration tool allows users having different roles to perform different tasks. A definer role allows the user to define configuration information to be used for the data transformation processes, wherein the definer can create a new configuration, modify existing unapproved but partially-defined configurations, and modify an approved and published configuration. An application approver role allows the user to review and approve configuration information that is specific to a single application. A global approver role allows the user to review and modify configuration information used by multiple applications. Further, an operator role allows the user to submit a job request for initiating data extraction and transformation processes without requiring the operator to have direct access to confidential production information. Of course, any other conceivable roles, and combinations thereof, are considered within the spirit and scope of the present invention. Further, a security facility, such as the ACCESS MANAGER facility manufactured by IBM, can be used to ensure that individuals are able to act in only those roles for which they have been explicitly authorized. Such a security facility ensures that individuals are able to create and approve configurations or submit transformation jobs for only those applications for which they have been authorized.

Importantly, the architecture 10 of the present invention can be implemented on any available computing platform, or even across multiple platforms. For example, the input data set 25, the data transformation system 30, and the output data set 45 could all be on a single platform, such as an IBM mainframe running the OS/390 or z/OS operating system, a SUN or IBM machine running the UNIX operating system, or on a computer running a version of the WINDOWS operating system. Alternatively, the input data set 25 could be a large data repository existing on an IBM mainframe running the OS/390 operating system, and the output data set could be a workgroup server running, for example, the UNIX operating system. Moreover, it is conceivable that the architecture 10 of the present invention could be implemented on a single machine, such as a PC, wherein the input data set 25 and the output data set 45 are two separate databases extant on the same machine. Even further, the architecture 10 of the present invention could be set up between two or more networks, wherein the input data set 25 resides on a secure portion of a corporate intranet and the output data set 45 exists on a less-secure portion of another (or the same) corporate intranet. Thus, the architecture 10 of the present invention is highly extensible, and can adapt to changing information system architectures.

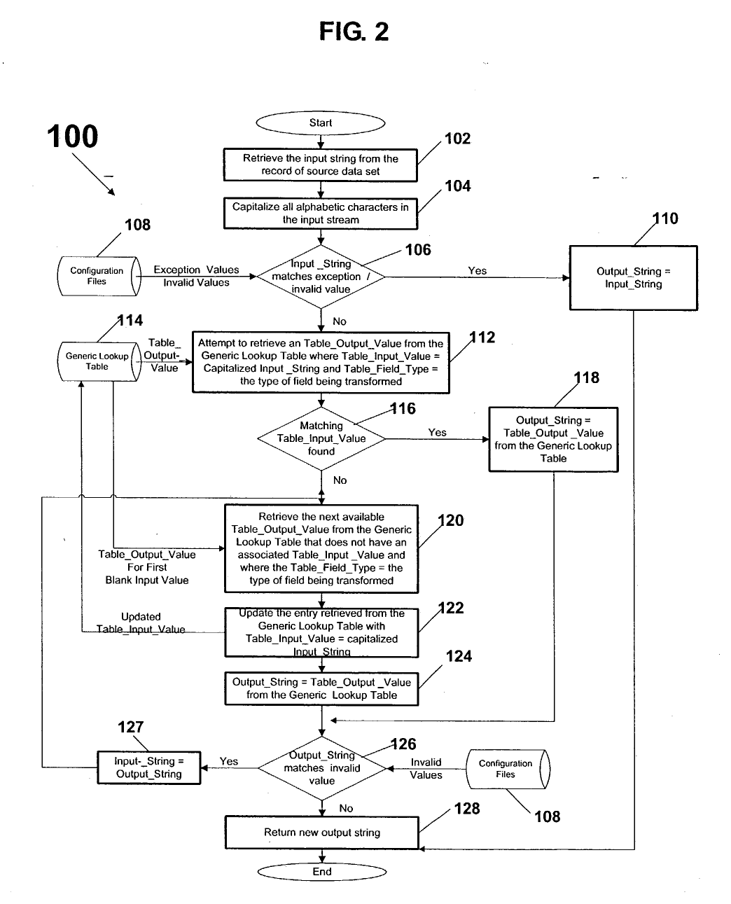

FIG. 2 is a flowchart showing a generic data transformation algorithm according to the present invention, indicated generally at 100. The generic data transformation algorithm allows an input value of any type (e.g., first name, last name, social security number, credit card number, account number, taxpayer identifier used in non-US countries, and vehicle registration number) to be transformed or scrubbed of confidential information, regardless of its data type, while ensuring that the transformed data complies with all formatting and data validation rules for the data type. The generic data transformation algorithm 100 also ensures that the uniqueness of unique identifiers is preserved (e.g., by ensuring that any specific input value will be transformed into one and only one output value, and that two input values will never be transformed into the same output value).

Beginning in step 102, an input value provided by a driver program (such as the driver program 37 of FIG. 1) is received. Then, in step 104, all alphabetic characters in the input string are capitalized. In step 106, the input string is compared to one or more exception or invalid values defined by the configuration tool 60 of FIG. 1 and stored in the configuration files 108. The exception values define one or more input string values for which transformation should not occur. For example, the exception values could be used by the generic algorithm 100 to determine that input values such as “UNKNOWN” and “NOT APPLICABLE” found in a last name or social security number field should not be transformed. Invalid values are values that are invalid for one or more of an organization's system. However, if such values exist in an input file (e.g., because they represent realistic though abnormal conditions that the system is expected to handle), they must be preserved in an output file to support realistic system processing. For example, while a social security number of “000000000” is invalid (because this number has never been issued), some systems may perform special processing when they encounter this value.

If a match between the input string and one or more of the exception or invalid values stored in configuration files 108 is detected, step 110 is invoked, wherein an output string is constructed and set to the input string. In this instance, transformation does not occur, and the output string is returned to the driver program 37 of FIG. 1 in step 128. In the event that a match between the input string and one or more of the exception or invalid values is not detected in step 106, then step 112 is invoked. In step 112, an attempt is made to retrieve a table output value from the generic lookup table 114 where a table input value matches the capitalized input string and a table field type matches the type of the input string. For example, if the input string is “SMITH” and the field type is “last name,” a matching record from the generic lookup table would have a table input value of “SMITH” and a table field value of “last name.” The table output value for the matching record contains substitute information that is used to replace confidential information in the input string and could contain, for example, the name “JONES.”

In step 116, a determination is made as to whether a matching record is found from the generic lookup table 114. If a positive determination is made, step 118 is invoked, wherein an output string is constructed using the table output value of the matching record. Then, step 126 is invoked, wherein an attempt is made to match the output string with one or more invalid values from the configuration files 108. If a match is detected, step 127 is invoked and sets the input string equal to the output string. Step 120 is then invoked to obtain a new output string. If no match with an invalid value is detected in step 126, the output string is then returned in step 128 to the driver program 37 of FIG. 1.

In the event that a negative determination is made in step 116, step 120 is invoked. In step 120, the next available table output value from the generic lookup table 114 is retrieved, wherein the table output value does not have an associated table input value and wherein the table field type is equal to the type of the input string. In step 122, the table input value of the record retrieved from the generic lookup table 114 is set to the capitalized input string, and the generic lookup table 114 is updated accordingly. Then, in step 124, an output string is constructed and set to the table output value of the retrieved record. Step 126, discussed earlier, is then invoked, wherein an attempt is made to match the output string with one or more invalid values from the configuration file 108. If a match is detected, step 127 is invoked and sets the input string equal to the output string. Then, step 120 is re-invoked to obtain a new output string. If no match with an invalid value is detected in step 126, the output string is returned to the driver program 37 of FIG. 1.

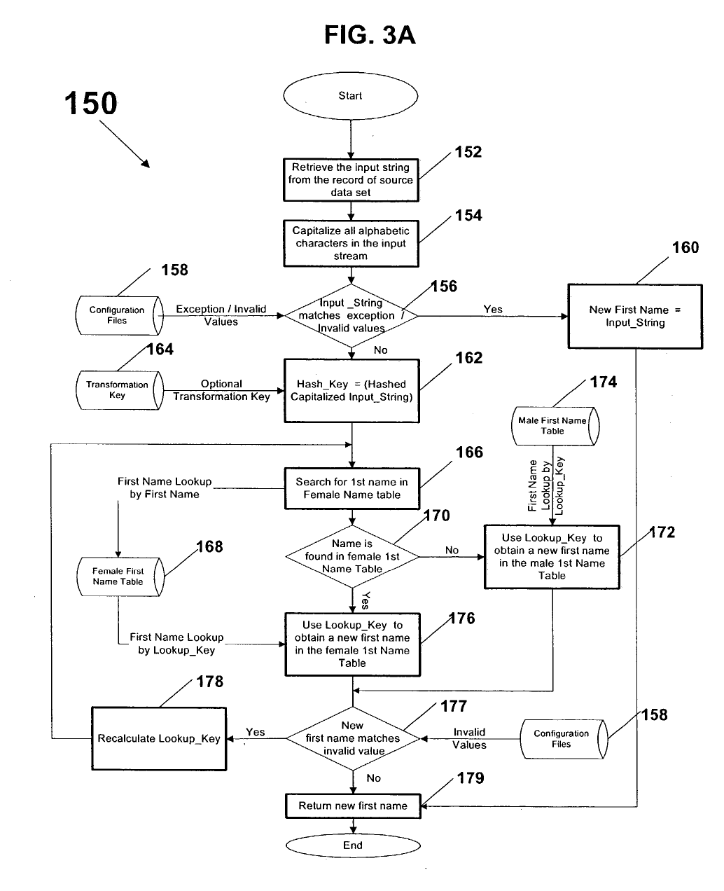

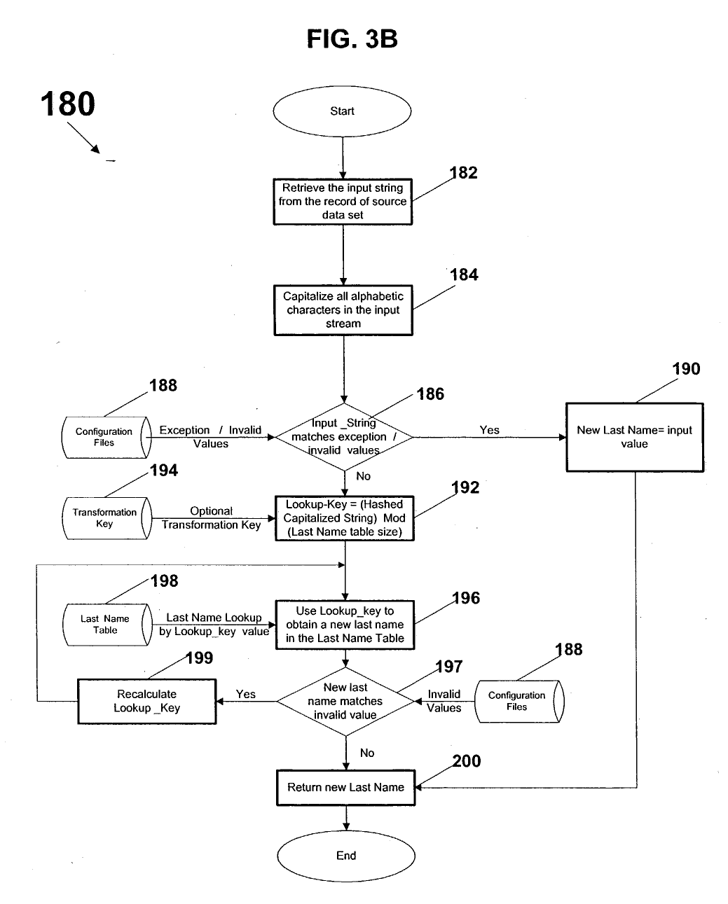

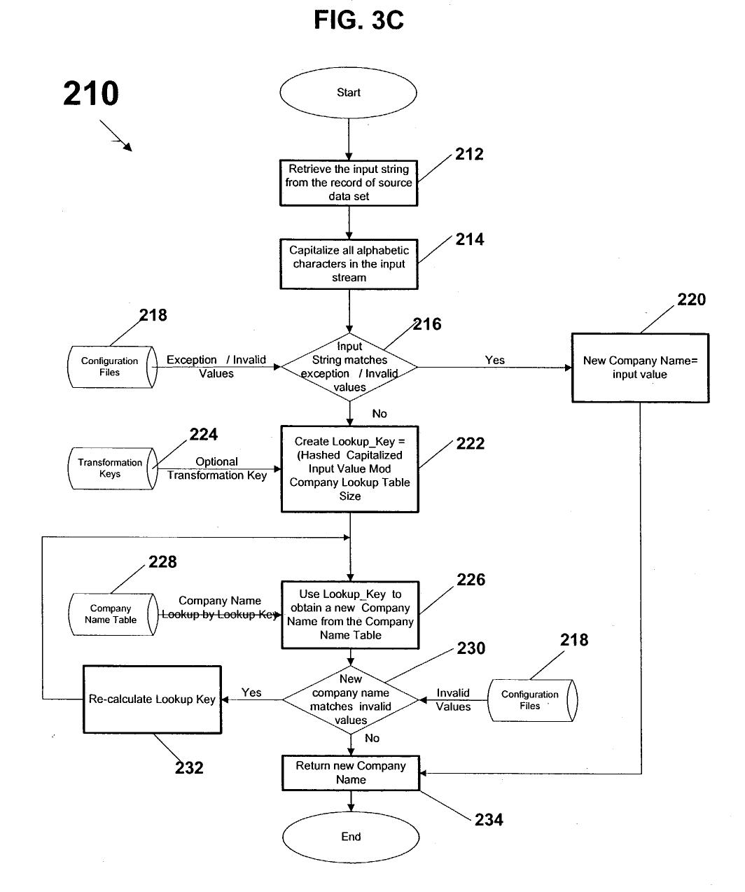

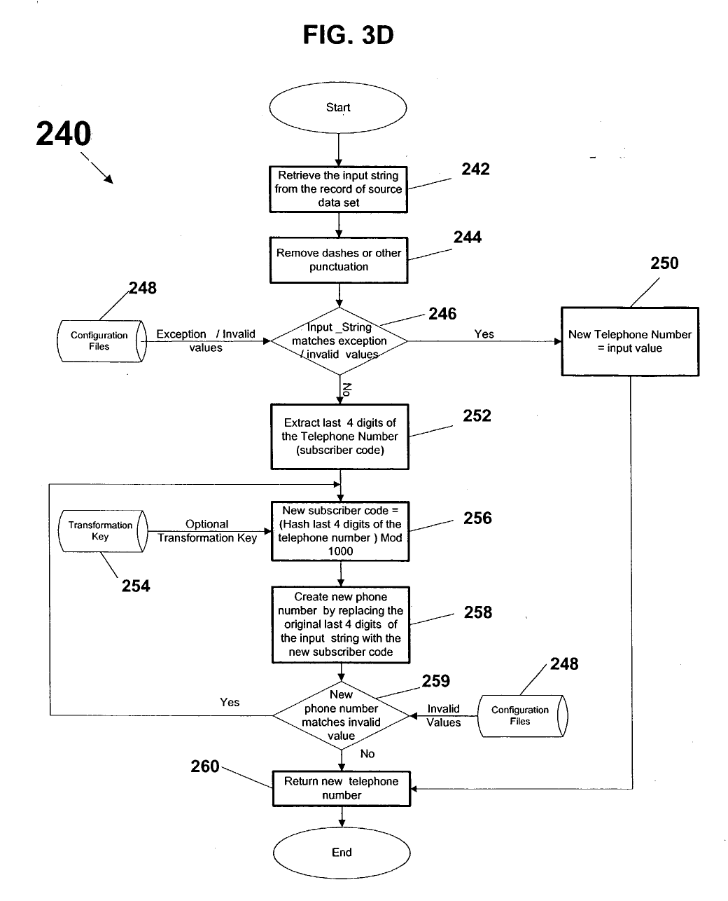

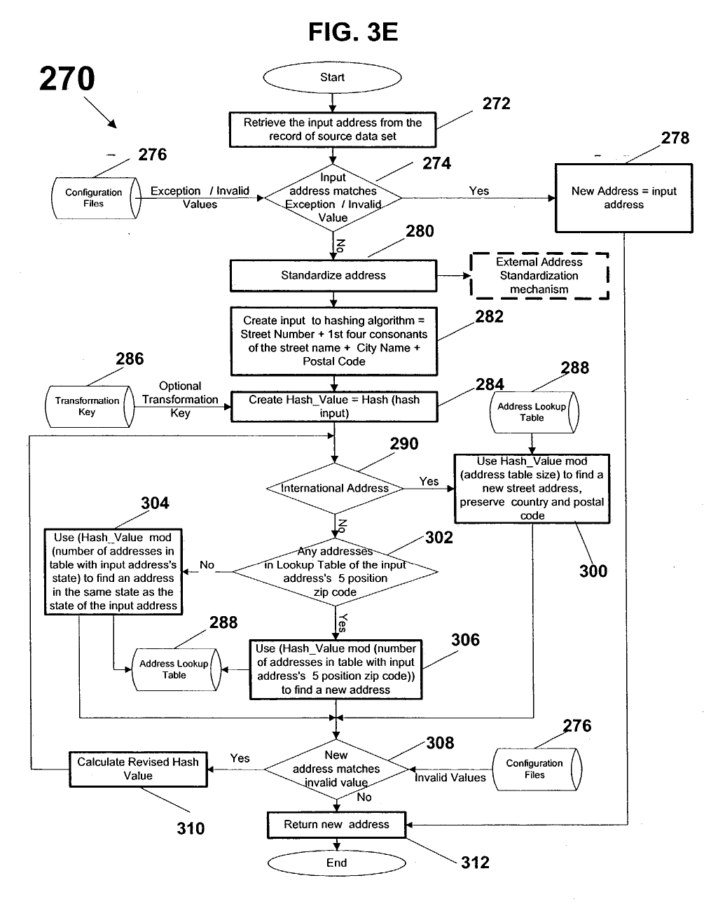

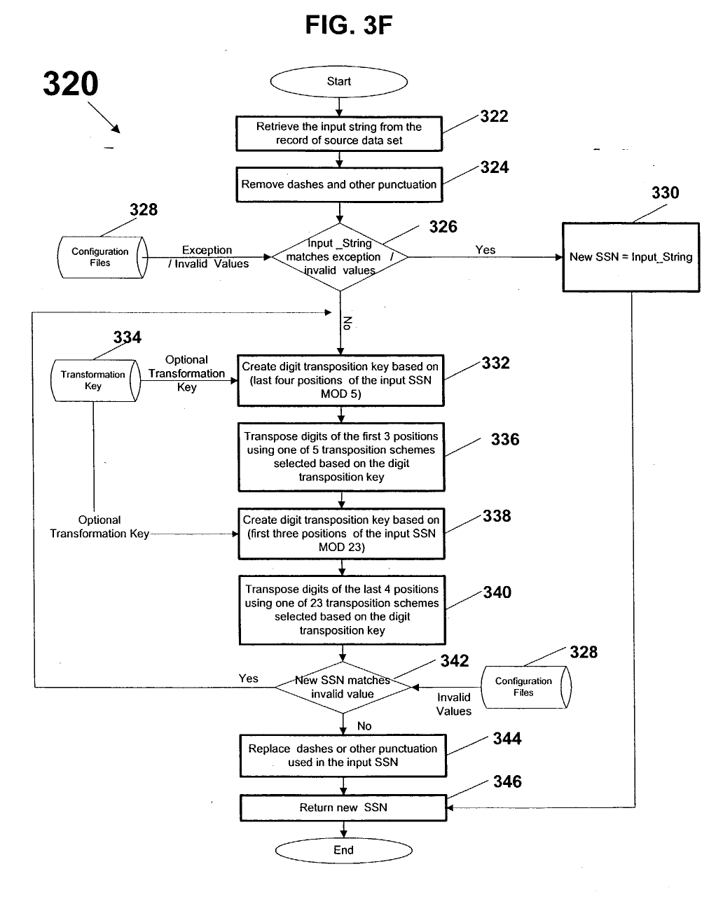

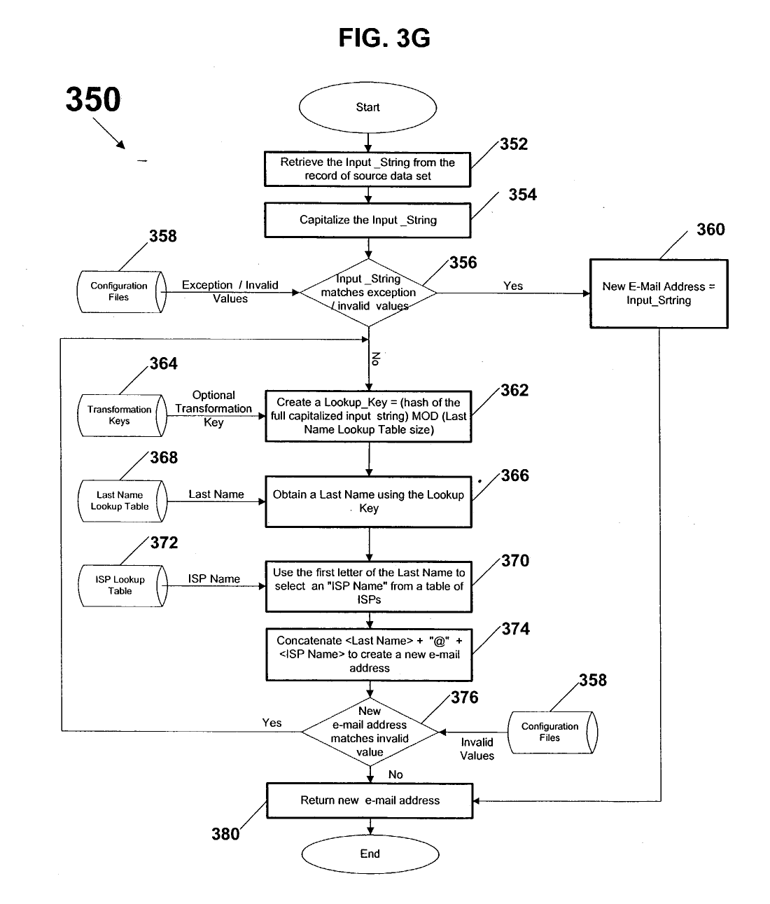

FIG. 3A is a flowchart showing a specific data transformation algorithm according to the present invention for disguising a first name, indicated generally at 150. This algorithm uses two lookup tables 168 and 174, one containing male first names (table 174) and the other containing female first names (table 168). The data transformation algorithm 150 allows an input record corresponding to a first name to be transformed or scrubbed of confidential information. Beginning in step 152, an input value is received from the driver program 37 of FIG. 1, and an input string is constructed. Then, in step 154, all alphabetic characters in the input string are capitalized. In step 156, the input string is compared to one or more exception or invalid values stored in configuration files 158 and defined by the configuration tool 60 of FIG. 1. The exception values define one or more input string values for which transformation should not occur. For example, exception information could be used to determine that input values such as “UNKNOWN” and “NOT APPLICABLE,” or all blank spaces, should not be transformed. Invalid values are values that are invalid for a particular system. However, if such values exist in an input file (e.g., because they represent realistic though abnormal conditions that the system is expected to handle), they must be preserved in an output file to support realistic system processing. If a match between the input string and an exception or invalid value is detected, step 160 is invoked, wherein a new first name is constructed and set to the input string. In this instance, transformation of the input string does not occur, and the new first name is returned to the driver program 37 of FIG. 1 via step 179.

In the event that a match between the input string and one or more of the exception values is not detected in step 156, then step 162 is invoked. In step 162, a hash value is generated for looking up a replacement first name from one of the gender-specific first name lookup tables 168 or 174. The hash value is preferably the hash of the capitalized input string, and can be expressed as follows:

Hash Value=(hash(capitalize(Input String))) Equation 1

The hash value is preferably an integer index value that can be used to create an index to retrieve a record from a first name lookup table. The hash function applied in Equation 1 above is preferably based upon a 128-bit secure hash standard (occasionally referred to as “SHA-1”). Of course, any known hash function could be applied to the capitalized input string to achieve a hash value.

Optionally, a transformation key 164 can be provided and utilized in step 162 to calculate the hash value. The transformation key 164, if provided, is combined with the lookup key value calculated in Equation 1, and provides an added degree of confidentiality and security for the transformation process by making it more difficult to reverse transformed (scrubbed) data. The transformation key 164 enables the same transformation routine to produce different hash values consistently (e.g., one transformation key may be used to disguise confidential information used by an organization's internal developers, and a second transformation key may be used to disguise confidential information used by external or outsourced developers). The transformation key 164 could be any value capable of being used in step 162 to change the value of the calculated hash value key.

Once the hash value has been calculated in step 162, step 166 is invoked, wherein a search for a first name is conducted in a female first name table 168 using the input string (original first name) value. A determination is made in step 170, and if a match does not occur, the original first name is presumed to be a male first name. Then, in step 172, a modulus function is applied to calculate a lookup key value, using the hash value as the first argument (input) and the size of the male first name tables as the second argument (input). The returned modulus value is an integer value that can then be utilized as an index or lookup key value. Further, in step 172, a lookup is performed in the male first name lookup table 174 using the lookup key value to obtain a new first name.

Then, step 177 is invoked, wherein the new first name is compared with one or more invalid values stored in the configuration files 158 and defined by the configuration tool 60 of the present invention. The invalid values are values to which the input string should not be transformed. For example, invalid values could be used to determine that an input first name should never be transformed into the output string “ZZZZZ” (e.g., because “ZZZZZ” has special meaning to a system that uses file being transformed). If no match is detected between the new first name and an invalid value, step 179 is invoked, wherein a new first name is returned to the driver program 37 of FIG. 1, based upon the new male first name retrieved in step 172. The output record contains a valid first name, wherein confidentiality of data in the input record is preserved and wherein a first name of the appropriate gender is selected whenever possible. In the event that a match between the new first name and an invalid value is detected in step 177, a new lookup key is calculated in step 178 and processing returns to step 166 to obtain a new first name.

In the event that a positive determination is made in step 170, the original first name is presumed to be a female first name. Then, in step 176, a modulus function is applied to calculate a lookup key value, using the hash value as the first argument (input) and the size of the female first name table as the second argument (input). The returned modulus value is an integer value that can then be utilized as an index or lookup key value. In step 176, a query is made into the female first name table 168 using the lookup key value to obtain a new female first name. In step 177, the new first name is compared with the invalid values 177. In the event that no match between the new female first name and an invalid value is detected in step 177, in step 179, a new first name (output record) is constructed and returned to the driver program 37 of FIG. 1 based upon the new female first name retrieved in step 176. In the event that a match is found in step 177 between the new female first name and an invalid value, a new lookup key is calculated in step 178 and processing returns to step 166 to obtain a new female first name.

FIG. 3B is a flowchart showing a specific data transformation algorithm according to the present invention for disguising a last name, indicated generally at 180. The data transformation algorithm 180 allows an input string corresponding to a last name to be transformed or scrubbed of confidential information. Beginning in step 182, an input value is retrieved from the driver program 37 of FIG. 1, and an input string is constructed from the retrieved value. Then, in step 184, all alphabetic characters in the input string are capitalized. In step 186, the input string is compared to one or more exception or invalid values stored in the configuration files 188 (defined by the configuration tool of the present invention), which represent one or more input string values for which transformation should not occur. For example, exception information could be used to determine that input values of “UNKNOWN” and “NOT APPLICABLE” should not be transformed. If a match between the input string and one or more of the exception or invalid values of the configuration files 188 is detected, step 190 is invoked, wherein a new last name is constructed and set to the input string. In this instance, transformation of the input string does not occur, and the new last name is returned to the driver program 37 of FIG. 1 in step 200.

In the event that a match between the input string and one or more of the exception values 188 is not detected in step 186, then step 192 is invoked. In step 192, a lookup key is generated for looking up a replacement last name from a last name lookup table. The lookup key is preferably the hash of the capitalized input string modulus the size of the last name lookup table, and can be expressed as follows:

Lookup Key=(hash(capitalize(Input String)))mod(size(Last Name Table)) Equation 2

The lookup key is preferably an integer index value that is utilized to retrieve a record from a last name lookup table. The hash function applied in Equation 2 above is preferably based upon the aforementioned SHA-1 standard, but any known hash function could be applied to the capitalized input string to achieve the hash value. A modulus function is then applied to calculate the lookup key value, using the hash value as the first argument (input) and the size of the last name table as the second argument (input). The returned modulus value is an integer value that can then be utilized as an index or lookup key value.

Optionally, a transformation key 194 can be provided, and utilized in step 192 to calculate the lookup key value. The transformation key 194, if provided, is combined with the lookup key value calculated in Equation 2, and provides an added degree of confidentiality and security for the transformation process by making it more difficult to reverse transformed (scrubbed) data. The transformation key 194 enables the same transformation routine to produce different values consistently (e.g., one transformation key may be used for disguising confidential information used by an organization's internal developers, and a second transformation key may be used to disguise confidential information used by external or outsourced developers). The transformation key 194 could be any value that can be used in step 192 to change the value of the calculated lookup key.

Once the lookup key has been calculated in step 192, step 196 is invoked, wherein a lookup of a last name is conducted in a last name lookup table 198 using the lookup key value. Then, in step 197, the new last name is compared with one or move invalid values defined by the configuration tool 60 and stored in the configuration files 188. In the event that no match between the new last name and an invalid value is detected in step 197, step 200 is invoked, wherein a new last name (output record) is constructed based upon the new last name retrieved in step 196 and returned to the driver program 37 of FIG. 1. In the event that a match between the new last name and an invalid value 188 is detected in step 197, a new lookup key is calculated in step 199 and a new last name is obtained in step 196.

FIG. 3C is a flowchart showing a specific data transformation algorithm according to the present invention for disguising a company name, indicated generally at 210. The data transformation algorithm 210 allows an input value corresponding to a company name to be transformed or scrubbed of confidential information. Beginning in step 212, an input value is retrieved from the driver program of the present invention, and an input string is constructed therefrom. Then, in step 214, all alphabetic characters in the input string are capitalized. In step 216, the input string is compared to one or more exception or invalid values stored in the configuration files 218 (defined by the configuration tool of the present invention), which represent one or more input string values for which transformation should not occur. For example, exception information could be used to determine that input values such as “UNKNOWN” and “NOT APPLICABLE” should not be transformed. If a match between the input string and one or more of the exception values is detected, step 220 is invoked, wherein a new company name is constructed and set to the input string. In this instance, transformation of the input string does not occur, and the new company name is returned to the driver program 37 of FIG. 1 in step 234.

In the event that a match between the input string and one or more of the exception values of the configuration files 218 is not detected in step 216, then step 222 is invoked. In step 222, a lookup key is generated for looking up a replacement company name from a company name lookup table. The lookup key is preferably the hash of the capitalized input string modulus the size of the company name lookup table, and can be expressed as follows:

Lookup Key=(hash(capitalize(Input String)))mod(size(Company Name Table)) Equation 3

The lookup key is preferably an integer index value that is utilized to retrieve a record from a company name lookup table. The hash function applied in Equation 3 above is preferably based upon the aforementioned SHA-1 standard, but any known hash function could be applied to the capitalized input string to achieve the hash value. A modulus function is then applied to calculate the lookup key value, using the hash value as the first argument (input) and the size of the company name lookup table as the second argument (input). The returned modulus value is an integer value that can then be utilized as an index or lookup key value.

Optionally, a transformation key 224 can be provided, and utilized in step 222 to calculate the lookup key value. The transformation key 224, if provided, is combined with the lookup key value calculated in Equation 3, and provides an added degree of confidentiality and security for the transformation process by making it more difficult to reverse transformed (scrubbed) data. The transformation key 224 enables the same transformation routine to produce different values consistently (e.g., one transformation key may be used to disguise confidential information used by an organization's internal developers, and a second transformation key may be used to disguise confidential information used by external or outsourced developers). The transformation key 224 could be any value that can be used in step 222 to change the value of the calculated lookup key.

Once the lookup key has been calculated in step 222, step 226 is invoked, wherein a search for a company name is conducted in a company name lookup table 228 using the lookup key value. In step 230, the new company name is compared with one or more invalid values stored in the configuration files 218 and defined by the configuration tool 60. In the event that no match between the new company name and an invalid value is detected in step 230, step 234 is then invoked, wherein a new company name (output record) is constructed based upon the new company name retrieved in step 226 and returned to the driver program 37 of FIG. 1. In the event that a match between the new company name and an invalid value is detected in step 234, a new lookup key is calculated in step 232, and a new company name obtained in step 226.

FIG. 3D is a flowchart showing a specific data transformation algorithm according to the present invention for disguising a telephone number, indicated generally at 240. The data transformation algorithm 240 allows an input value corresponding to a telephone number to be transformed or scrubbed of confidential information. Beginning in step 242, an input value is received from the driver program of the present invention, and an input string is constructed. Then, in step 244, all dashes or other punctuation in the input string are removed.

In step 246, the input string is compared to one or more exception or invalid values stored in configuration files 248 (defined by the configuration tool of the present invention), which represent one or more input string values for which transformation should not occur. For example, exception information could be used to determine that input values such as “9999999999,” “0000000000,” and “UNKNOWN,” should not be transformed. If a match between the input string and one or more of the exception or invalid values is detected, step 250 is invoked, wherein a new telephone number is constructed and set to the input string. In this instance, transformation of the input string does not occur, and the new telephone number is returned to the driver program 37 of FIG. 1 in step 260.

In the event that a match between the input string and one or more of the exception or invalid values is not detected in step 246, then step 252 is invoked. In step 252, the last four digits of the input string (telephone number) are extracted, said digits corresponding to a subscriber code. Then, in step 256, a new subscriber code is created by calculating the hash of the last four digits of the input string (telephone number) modulus one thousand, and can be expressed as follows:

New Subscriber Code=(hash(last_{—}4_digits(Input String)))mod 1000 Equation 4

The “last_{—}4_digits” function shown above retrieves the last four digits of the input string, which correspond to the original subscriber code. Once calculated, a hash function is applied to the last four digits to produce a hash value. The hash function applied in Equation 4 above is preferably based upon the aforementioned SHA-1 standard, but any known hash function could be applied to the last four digits of the input string to achieve the hash value. A modulus function is then applied to calculate the new subscriber code, using the hash value as the first argument (input) and 1000 as the second argument (input).

Optionally, a transformation key 254 can be provided, and utilized in step 256 to calculate the new subscriber code. The transformation key 254, if provided, is combined with the subscriber code value calculated in Equation 4, and provides an added degree of confidentiality and security for the transformation process by making it more difficult to reverse transformed (scrubbed) data. The transformation key 254 enables the same transformation routine to produce different values consistently (e.g., one transformation key may be used to disguise confidential information used by an organization's internal developers, and a second transformation key may be used to disguise confidential information used by external or outsourced developers). The transformation key 254 could be any value that could be used in step 256 to change the way the new subscriber code is calculated.

Once the new last four digits of the phone number have been calculated in step 256, step 258 is invoked, wherein a new phone number is created by replacing the original last four digits of the input string with the new subscriber code calculated in step 256. The output value contains a telephone number structurally similar to the original telephone number, wherein confidentiality of data in the input record is preserved. In step 259, the new telephone number is compared with one or more invalid values defined by the configuration tool 60 and stored in the configuration files 248. In the event that no match is found between the new telephone number and an invalid value, then in step 260, the disguised telephone number is returned to the driver program 37 of FIG. 1. In the event that a match between the new telephone number and an invalid value is detected in step 259, a new subscriber code is calculated in step 256 using the previously calculated subscriber code as input.

FIG. 3E is a flowchart showing a specific data transformation algorithm according to the present invention for disguising an address, indicated generally at 270. The data transformation algorithm 270 allows an input value corresponding to an address to be transformed or scrubbed of confidential information. The present invention can handle addresses in any format, including address formats in which different elements of the address are stored in different fields (e.g., address lines, city, state, zip) and formats in which all elements of an address are stored in a single field. Beginning in step 272, a value from the driver program of the present invention is retrieved, and an input string is constructed from the retrieved value. Then, in step 274, each address element (e.g., address line, city, state, zip code) of the input string is compared to one or more exception or invalid values stored in configuration files 276 (defined by the configuration tool of the present invention), which represent one or more input string values for which transformation should not occur. For example, exception information could be used to determine that input values of “UNKNOWN” and “NOT APPLICABLE,” should not be transformed. If a match between the input string and one or more of the exception values is detected, step 278 is invoked, wherein a new address is constructed and set to the input string. In this instance, transformation of the input string does not occur, and the new address is returned to the driver program 37 of FIG. 1 in step 312.

In the event that a match between the input string and one or more of the exception or invalid values is not detected in step 274, then step 280 is invoked. In step 280, the address is standardized into a common address format using a customized or vendor-provided address formatting utility. An example of a vendor-provided address formatting utility is the FINALIST product manufactured by PITNEY BOWES, INC. Of course, any suitable address formatting utility could be used in step 280 without departing from the spirit or scope of the present invention.

In step 282, a hash input value is created by concatenating the street number in the input string, the first four consonants of the street name, the city name, and the postal code. The hash input value can be expressed as follows:

Hash Input Value=Street Number+First Four Consonants of Street Name+City Name+Postal Code Equation 5

In step 284, a hash value is created for retrieving a substitute address from an address lookup table. The hash value is preferably the hash of the hash input value calculated in step 282, and can be expressed as follows:

Hash Value=(hash(Hash Input Value)) Equation 6

The hash value is preferably an integer value that can be used to construct an index value that is utilized to retrieve a record from an address lookup table. The hash function applied in Equation 6 above is preferably based upon the aforementioned SHA-1 standard, but of course, any known hash function could be applied to the hash input value to achieve a hash value.

Optionally, a transformation key 286 can be provided, and utilized in step 284 to calculate the hash value. The transformation key 286, if provided, is combined with the hash value calculated in Equation 6, and provides an added degree of confidentiality and security for the transformation process by making it more difficult to reverse transformed (scrubbed) data. The transformation key 286 enables the same transformation routine to produce different values consistently (e.g., one transformation key may be used to disguise confidential information used by an organization's internal developers, and a second transformation key may be used to disguise confidential information used by external or outsourced developers). The transformation key 286 could be any value that can be used in step 284 to change the value of the calculated hash value.

Once the hash value has been calculated in step 284, step 290 is invoked, wherein a determination is made as to whether the address is an international address. If a positive determination is made, step 300 is invoked, wherein a query is made into the address lookup table 288 to find a new street address. The query uses a key value corresponding to the hash value modulus the address lookup table size. The original country and postal code of the input string is preserved, and a new address is created using the new street address line, original country, and original postal code.

In the event that a negative determination is made in step 290, a second determination is made in step 302 as to whether any addresses in the address lookup table exist having the same 5 position zip code as the address of the input string. If a negative determination is made, step 304 is invoked, wherein a query is made into the address lookup table 288 to find an address having the same state as the input address. The query uses a key corresponding to the hash value modulus the number of addresses in the address lookup table of the same state as the state of the input address.

In the event that a positive determination is made in step 302, step 306 is invoked, wherein the hash value is used to find an address in the address lookup table 288. The query uses a key corresponding to the hash value modulus the number of addresses in the address lookup table of the same 5 position zip code as that of the input address. In step 308, the new address is compared with one or more invalid values defined by the configuration tool 60 and stored in the configuration files 276. If a match between the new address and an invalid value is detected, a new hash value is calculated in step 310 and used to obtain a new address. In step 312 the new address is returned to the driver program 37 of FIG. 1. The new address is structurally similar to the original address, but wherein confidentiality of the data in the input record is preserved. The new US addresses are legitimate US addresses that can be validated by standard vendor-provided address verification utilities (e.g., the FINALIST product manufactured by PITNEY BOWES, INC.).

FIG. 3F is a flowchart showing a specific data transformation algorithm according to the present invention for disguising a social security number, indicated generally at 320. The data transformation algorithm 320 allows an input value corresponding to a social security number to be transformed or scrubbed of confidential information. Beginning in step 322, a value from the driver program of the present invention is retrieved, and an input string is constructed. Then, in step 324, all dashes or other punctuation in the input string are removed. In step 326, the input string is compared to one or more exception or invalid values stored in configuration files 328 (defined by the configuration tool of the present invention), which represent one or more input string values for which transformation should not occur. For example, the exception information could be used to determine that input values such as “9999999999,” “0000000000,” and “UNKNOWN,” or all blank spaces, should not be transformed. If a match between the input string and one or more of the exception values 328 is detected, step 330 is invoked, wherein a new social security number is constructed and set to the input string. In this instance, transformation of the input string does not occur, and the new social security number is returned to the driver program 37 of FIG. 1 in step 346.

In the event that a match between the input string and one or more of the exception values is not detected in step 326, then step 332 is invoked. In step 332, a digit transposition key is created based upon the last four digits of the input string (social security number) modulus 5. The digit transposition key can be expressed as follows:

Digit Transposition Key=(last_{—}4_digits(Input String))mod 5 Equation 7

The “last 4_digits” function shown above retrieves the last four digits of the input string, which correspond to the last four digits of the original social security number. Then, a modulus function is then applied to calculate the digit transposition key, using the last four digits of the input string as the first argument (input) and 5 as the second argument (input).

Optionally, a transformation key 334 can be provided, and utilized in step 332 to calculate the digit transposition key. The transformation key 334, if provided, is combined with the digit transposition key calculated in Equation 7, and provides an added degree of confidentiality and security for the transformation process by making it more difficult to reverse transformed (scrubbed) data. The transformation key 334 enables the same transformation routine to produce different values consistently (e.g., one transformation key may be used to disguise confidential information used by an organization's internal developers, and a second transformation may be used to disguise confidential information used by external or outsourced developers). The transformation key 334 could be any value that can be used in step 332 to change the value of the calculated transposition key.

Once the digit transposition key has been calculated in step 332, step 336 is invoked, wherein the first three positions of the input string are transposed using one of five transposition schemes selected based upon the digit transposition key. The values of digit transposition keys correspond to the five possible ways in which the first three digits of the input string can be transposed. For example, if the transposition key is set to “1,” then the first three digits could be transposed as follows: value in input position 1 moved to output position 3; value in input position 2 moved to output position 1; value in input position 3 moved to output position 2. Then, in step 338, a second digit transposition key is created based upon the first three positions of the input string modulus 23. The second digit key can be expressed as follows:

Second Digit Transposition Key=first_{—}3_digits(Input String))mod 23 Equation 8

The “first_{—}3_digits” function shown above retrieves the first three digits of the input string, which correspond to the first three digits of the original social security number. Then, a modulus function is applied to calculate the second digit transposition key, using the first three digits of the input string as the first argument (input) and 23 as the second argument (input). Optionally, transformation key 334, discussed earlier, can be provided, and utilized in step 338 to calculate the digit transposition key. The transformation key 334, if provided, is combined with the second digit transposition key calculated in Equation 8, and provides an added degree of confidentiality and security for the transformation process by making it more difficult to reverse transformed (scrubbed) data. The transformation key 334 could be any value that can be used in step 338 to change the value of the transposition key that is calculated.

In step 340, the last four positions of the input string are transposed using one of 23 transposition schemes selected based upon the second digit transposition key. The values of digit transposition keys correspond to the twenty-three possible ways in which the last four digits of the input string can be transposed. For example, if the second digit transposition key is “13,” the last four digits of the input string could be transposed as follows: value in input position 1 moved to output position 3; value in input position 2 moved to output position 1; value in input position 4 moved to output position 2; and value in input position 3 moved to output position 4.

In step 342, the new social security number is compared with one or more invalid values stored in configuration files 328 and defined by the configuration tool 60. In the event that no match between the social security number and an invalid value is detected in step 342, dashes and other punctuation are replaced in step 344. In step 346, the new social security number is returned to the driver program 37 of FIG. 1. The new social security number contains a value that is structurally similar to the original social security number, and wherein confidentiality of data in the input record is preserved. In the event that a match between the new social security number and an invalid value is detected in step 342, the new social security number is used as input to step 332 to create a new, valid social security number.

FIG. 3G is a flowchart showing a specific data transformation algorithm according to the present invention for disguising an e-mail address, indicated generally at 350. The data transformation algorithm 350 allows an input value corresponding to an e-mail address to be transformed or scrubbed of confidential information. Beginning in step 352, a value from the driver program of the present invention is received, and an input string is constructed therefrom. Then, in step 354, all alphabetic characters in the input string are capitalized. In step 356, the input string is compared to one or more exception or invalid values stored in configuration files 358 (defined by the configuration tool of the present invention), which represent one or more input string values for which transformation should not occur. If a match between the input string and an exception or invalid value is detected, step 360 is invoked, wherein a new e-mail address is constructed and set to the input string. In this instance, transformation of the input string does not occur, and the new e-mail address is returned to the driver program 37 of FIG. 1 in step 380.

In the event that a match between the input string and one or more of the exception values is not detected in step 356, then step 362 is invoked. In step 362, a lookup key is generated for looking up a name from a last name lookup table. The lookup key is preferably the hash of the capitalized input string modulus the size of the last name lookup table, and can be expressed with reference to Equation 2, discussed earlier. Optionally, a transformation key 364 can be provided, and utilized in step 362 to calculate the lookup key value. The transformation key 364, if provided, is combined with the lookup key value calculated in Equation 2, and provides an added degree of confidentiality and security for the transformation process by making it more difficult to reverse transformed (scrubbed) data. The transformation key 364 enables the same transformation routine to produce different values consistently (e.g., one transformation key may be used to disguise confidential information used by an organization's internal developers, and a second transformation key may be used to disguise confidential information used by external our outsourced developers). The transformation key 364 could be any value that can be used in step 362 to change the value of the calculated lookup key.

Once the lookup key has been calculated in step 362, step 366 is invoked, wherein a search for a last name is conducted in a last name lookup table 368 using the lookup key value. Step 370 is then invoked, wherein an Internet Service Provider (ISP) name is located in ISP lookup table 372 using the first letter of the last name retrieved in step 366 as a lookup key. In step 374, the last name retrieved in step 366 is concatenated with an “1” symbol and the ISP name retrieved in step 370 to produce a new e-mail address.

In step 376, the new e-mail address is compared with one or more invalid values stored in the confirmation files 358 and defined by the configuration tool 60. In the event that no match is detected between the new e-mail address and an invalid value in step 376, then in step 380, the new e-mail address is returned to the driver program 37 of FIG. 1. The output record contains an e-mail address structurally similar to the original e-mail address, wherein confidentiality of data in the input record is preserved. In the event that a match between the new last name and an invalid value is detected in step 376, the new but invalid e-mail address is used as input to step 362 to calculate a new address.

While specific embodiments of the data transformation algorithms of the present invention have been discussed with relation to FIGS. 3A-3G, it is to be expressly understood that the present invention can be expanded to transform any conceivable data type in accordance with the methodologies disclosed herein to purge confidential information from an input data set. For example, data transformation algorithms could be developed for transforming driver's license numbers, credit card numbers, bank account numbers, insurance policy numbers, dates of birth, or other similar types of personal information. Thus, as can be readily appreciated, the present invention is extensible to allow the disguising of confidential information of any type.

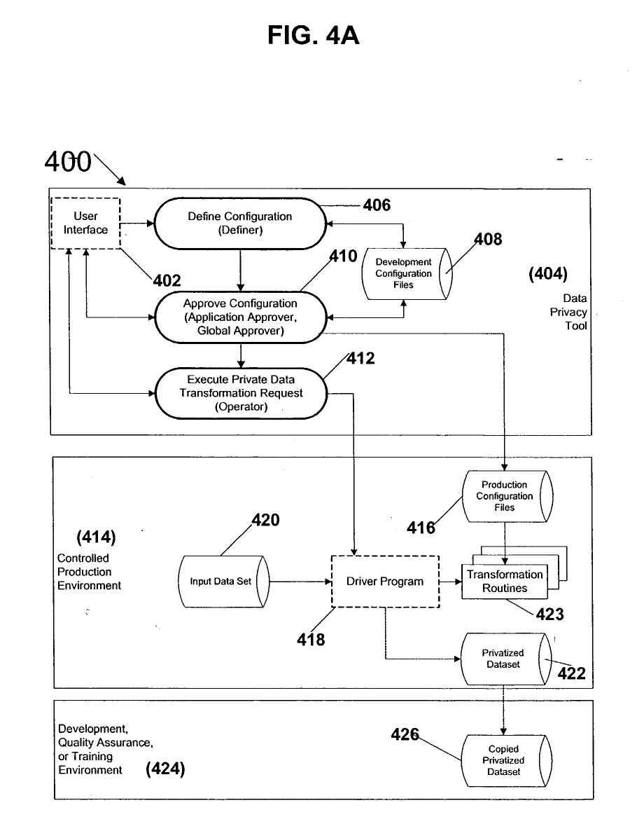

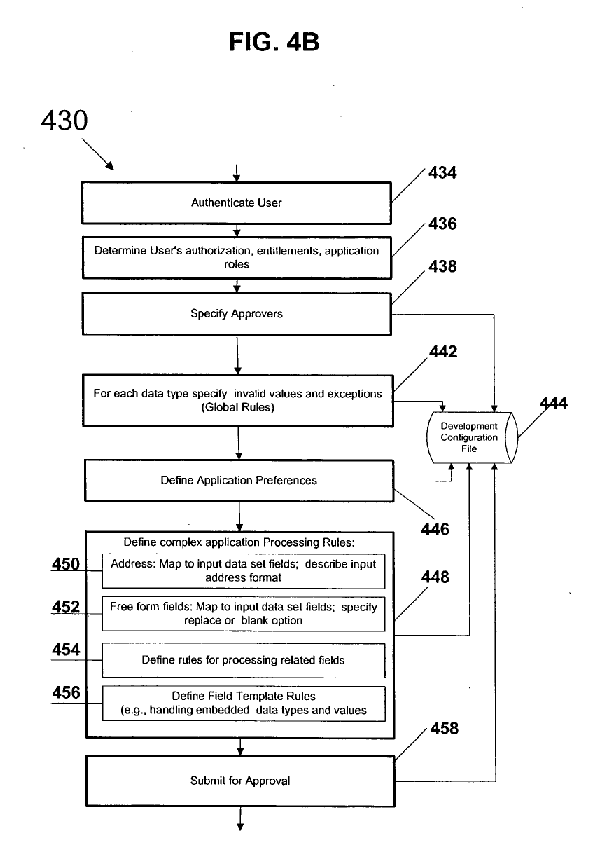

FIG. 4A is a flowchart showing processing logic of the overall data privatization process of the present invention, indicated generally at 400. As mentioned earlier, the present invention provides a configuration tool for allowing users of different roles to define and approve rules for controlling the data transformation process, and for allowing the initiation of data transformation requests. Such interaction is provided via a user interface 402, which could be a graphical user interface operable on any conceivable platform. In a preferred embodiment of the present invention, the user interface 402 is a web-based application that operates in any standard web browser, such as INTERNET EXPLORER by MICROSOFT. Of course, it is conceivable that the user interface 402 could be a stand-alone application developed for any suitable operating system, such as WINDOWS, LINUX, UNIX, or other known operating system.

The data privacy tool 404 of the present invention allows users having disparate roles to perform different tasks. In process 406, a user having a “definer” role could create and define transformation rules and parameters (e.g., exception and invalid values) that are stored in a development configuration file 408. In process 410, the defined rules and parameters could be approved by a user having an “application approver” or “global approver” role. In process 412, an “operator” could execute a data transformation request that would use the production configuration file 416. Other roles and tasks are conceivable.

Transformation rules and parameters created using the data privacy tool 404 are transferred to a controlled production environment 414, and stored in a production configuration file 416 for controlling the data privacy routines 423 that are invoked by a driver program, such as the driver program 37 of FIG. 1. The driver program 418 coordinates the invocation of the data transformation algorithms, discussed earlier, using information from the configuration files 416. The driver program 418 is initiated by a user having operator status. Data from the input data set 420 is then disguised in accordance with the processes discussed earlier, and output to a privatized dataset 422 containing data that is structurally similar to the input data set but contains no confidential information. Once generated, the privatized dataset 422 could be copied to a secondary privatized dataset 426, for use in a development, quality analysis, or training environment 424.

FIG. 4B is a flowchart showing additional processing logic of the configuration tool of the present invention for creating a new set of configuration files, indicated generally at 430. A user login process 434 allows the user to log in and be authenticated. Such authentication could be accomplished using any vendor-provided (e.g., RACF) authentication facilities, login/password files, or other known authentication methodology. In step 436, the user's authorization, entitlements, and application roles are ascertained. Then, in step 438, approvers are specified for configuration files associated with an application, and stored in a set of development configuration files 444. In step 442, for each data type that exists, invalid and exception values may be defined. Such values are referred to as “global rules,” and define situations and input values where transformation should not occur (e.g., an address having a value of “UNKNOWN” should not be transformed; an input value for a social security number should not be transformed into the value “111-11-1111”). Global rules apply across all of an organization's files or databases, and are not specific to a single file or database. The global rules are stored in the configuration files 444.

In step 446, application preferences are defined and stored in the configuration files 444. Such preferences could include, but are not limited to, the use of mixed or upper case letters in input and output records used by a specific application. Then, in step 448, complex application processing rules are defined and also stored in the configuration files 444. Unlike global rules and parameters that apply to all files and databases, the rules defined in step 448 apply to a single application, file, or database. In step 450, rules are defined for transforming addresses, wherein input data set fields are mapped to specific address field data types. In step 452, rules are defined for transforming free-form fields (such as string fields), wherein input data set fields are mapped and replacement and blank options are defined. In step 454, rules for processing related fields are defined (e.g., rules describing the location of the code values that can be used to identify US-style addresses for use by the address transformation algorithm, discussed earlier). Further, in step 456, field template rules are defined. Such rules define how to handle embedded data types and values. Other complex application processing rules could be defined in step 448. Finally, in step 458, the defined rules stored in the development configuration files 444 are submitted for approval.

When a set of development configuration files 444 has been created, the rules can quickly be approved by a user via the configuration tool of the present invention. A user having approver status can log in, retrieve one or more requests to approve a set of development configuration files, review same within the user interface of the configuration tool, and either approve or reject the request. If the decision is made to approve the request, information from the set of development configuration files (such as the configuration files 408 of FIG. 4A) is copied to a set of production configuration files (such as the configuration files 416 of FIG. 4A). Once the configuration files are approved, a transformation request can be initiated by a user having operator status, using the configuration tool of the present invention. The request can be processed immediately, or sent to a job scheduling facility (e.g., a mainframe job scheduler) for execution at a pre-determined time.

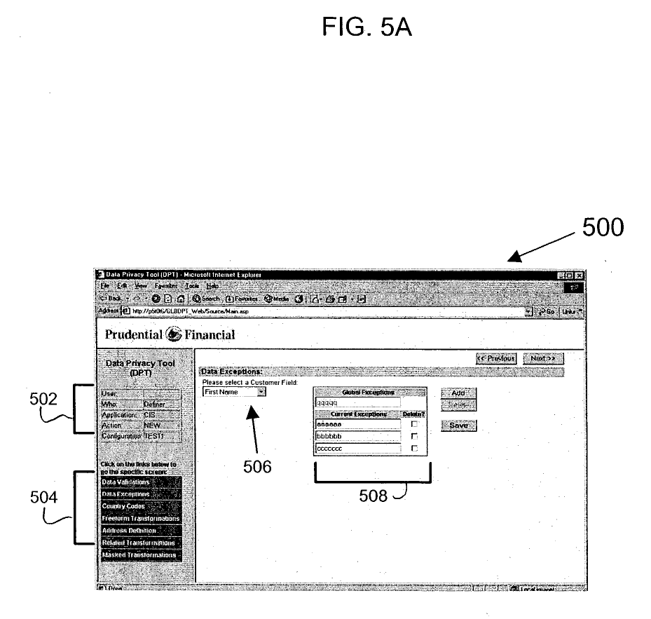

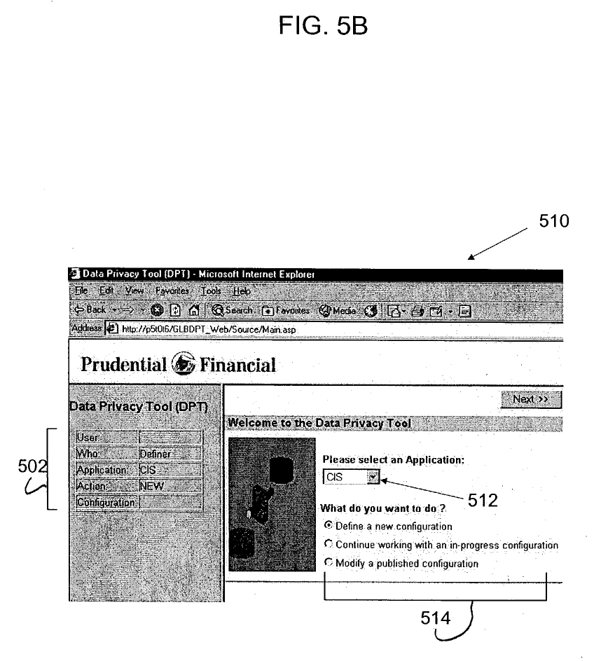

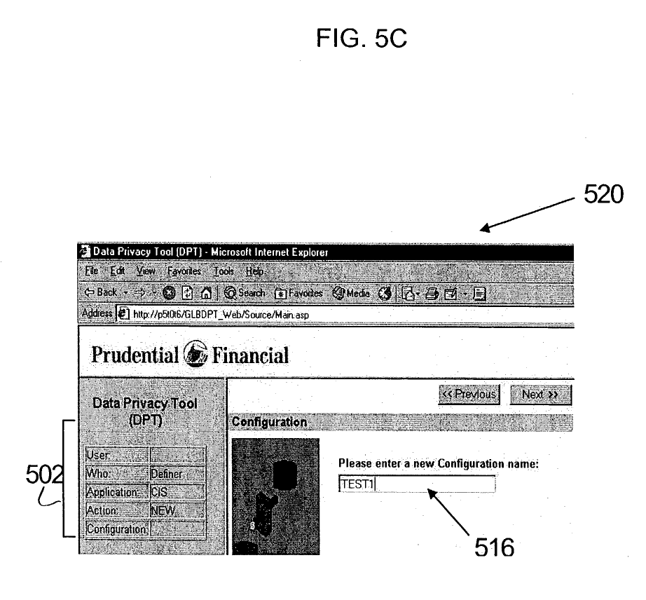

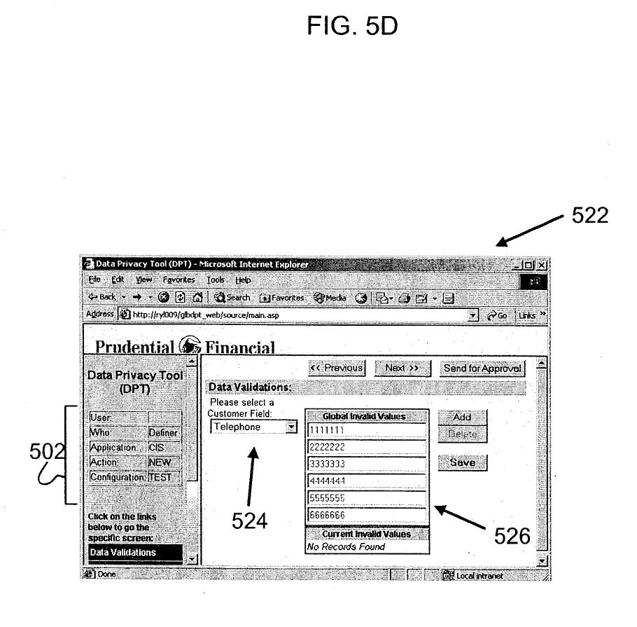

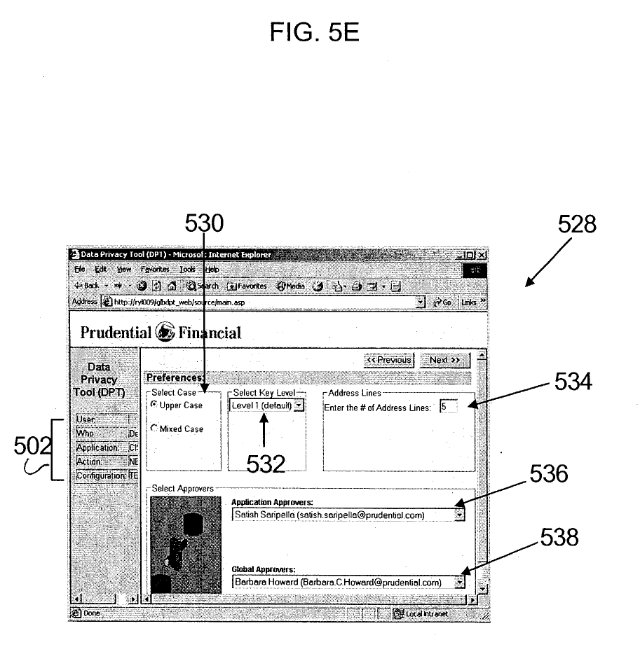

FIGS. 5A-5E are screenshots showing the configuration tool of the present invention. Beginning with FIG. 5A, there is shown a user interface screen 500 for allowing user to define data transformation exceptions. A first panel 502 provides the user with information about the user's current name, role, application, and configuration. A second panel 504 allows the user to execute various functions by clicking on one or more buttons. The functions include data validation, data exception definitions, country codes, freeform transformations, address definitions, related transformations, and masked transformations. In pull-down element 506, a user can select a customer field for which a data transformation exception is to be defined. In panel 508, the user can view current exceptions and enter new exceptions. The exceptions can be added, saved, or deleted. Further, the user can navigate the interface screen 500 by clicking on the “previous” and “next” buttons appearing at the top right of the screen.

FIG. 5B is a screenshot of another user interface screen 510 of the configuration tool of the present invention. In this screen, the user can select an application for which a set of configuration files can be created, modified, approved, or submitted. The desired application is selected via pull-down element 512, and the tasks are selected by clicking on radio button element 514. The user can, for example, define a new configuration, continue to work with a configuration currently in progress, or modify a published application. The first panel 502, discussed earlier, conveniently provides the user with current login and context information.

FIG. 5C is a screenshot of another user interface screen 520 of the configuration tool of the present invention. In this screen, field 516 allows the user to enter the name of a new configuration to be defined. The new configuration will then be saved according to the name given by the user. The new configuration can be manipulated immediately, or later retrieved and edited.

FIG. 5D is a screenshot of another user interface screen 522 of the configuration tool of the present invention. In this screen, the user can enter a variety of data validation rules. A privacy data type is selected via pull-down element 524 that indicates the type of field for which validation rules are to be defined. For example, validation rules for a telephone number could be defined (e.g., no telephone number should be transformed into the value “1111111111”). In panel 526, the user defines invalid values. These invalid values, once defined, allow the present invention to prohibit transformation thereof of input values into invalid output values. The validation rules can be saved, submitted immediately for approval, or later retrieved for editing.

FIG. 5E is a screenshot of another user interface screen 528 of the configuration tool of the present invention. In this screen, the user can define a multitude of preferences for transformation processes. For example, in panel 530, the user can indicate whether input files or databases are in mixed or upper case. In panel 532, a transformation key can be selected. In panel 534, the number of lines for an address type can be defined. In pull-down element 536, the application approver can be selected. Further, in pull-down element 538, the global approver can be selected.

In conclusion, the present invention provides a system and method for disguising data, wherein confidential information from an input data set is removed and an output data set having non-confidential information is provided. Input data records are consistently transformed, such that in successive transformations, a given input data value is transformed into the same output data value. Differences in input data records are tolerated, wherein, for example, the addresses corresponding to “121 Main Street” and “121 Main St.” are transformed to the same output value. Additionally, important attributes of the input data records, including formatting, punctuation, hyphenation, and other attributes, are preserved in the output data set.

Having thus described the invention in detail, it is to be understood that the foregoing description is not intended to limit the spirit and scope thereof. What is desired to be protected by Letters Patent is set forth in the appended claims.

What is claimed is:

1. A method for disguising and de-identifying data comprising:
retrieving an input value from an input data set containing confidential information;
generating an index value based upon the input value;
retrieving a substitute value from a lookup table using the index value, the substitute value containing non-confidential information;
constructing an output value based upon the substitute value; and
storing the output value in an output data set.

2. The method of claim 1, wherein the step of generating the index value comprises hashing the input record to provide a hash value.

3. The method of claim 2, further comprising applying a modulus function to the hash value to produce the index value.

4. The method of claim 1, wherein the step of retrieving the substitute value comprises retrieving a substitute first name from a first name lookup table if the input value corresponds to a first name.

5. The method of claim 1, wherein the step of retrieving the substitute value comprises retrieving a substitute last name from a last name lookup table if the input value corresponds to a last name.

6. The method of claim 1, wherein the step of retrieving the substitute value comprises retrieving a substitute company name from a company name lookup table if the input value corresponds to a company name.

7. The method of claim 1, wherein the step of retrieving the substitute value comprises retrieving a substitute street address from an address lookup table if the input value corresponds to an address.

8. The method of claim 7, wherein the step of constructing the output value comprises constructing a new address using the substitute street address, an original state, and an original postal code.

9. The method of claim 1, wherein the step of retrieving the substitute value comprises retrieving a substitute ISP name from an ISP lookup table if the input value corresponds to an e-mail address.

10. The method of claim 9, wherein the step of constructing the output value comprises constructing a new e-mail address using the substitute ISP name and a substitute last name.

11. The method of claim 1, further comprising allowing a user to control data transformation using a configuration tool.

12. The method of claim 11, further comprising allowing the user to define, approve, and initiate a data transformation process using the configuration tool.

13. The method of claim 1, further comprising modifying an existing telephone number from the input value to remove confidential information if the input value corresponds to a telephone number.

14. The method of claim 13, wherein the step of constructing the output value comprises constructing a new telephone number based upon a modified existing telephone number.

15. The method of claim 1, further comprising modifying an existing social security number from the input value to remove confidential information if the input value corresponds to a social security number.

16. The method of claim 15, wherein the step of constructing the output value comprises constructing a new social security number based upon a modified existing social security number.

17. A method for disguising and de-identifying data comprising:
retrieving an input value from an input data set containing confidential information;
generating a transformation key based upon the input value;
manipulating the input value based upon the transformation key to produce an output value containing non-confidential information; and
storing the output value in an output data set.

18. The method of claim 17, wherein the step of generating the transformation key comprises generating a digit transposition key based upon the input value.

19. The method of claim 18, wherein the step of manipulating the input value comprises transposing digits of the input value based upon the digit transposition key.

20. The method of claim 17, wherein the step of manipulating the input value comprises transposing a portion of an existing telephone number to remove confidential information if the input value corresponds to a telephone number.

21. The method of claim 17, wherein the step of manipulating the input value comprises transposing a portion of an existing social security number to remove confidential information if the input value corresponds to a social security number.

22. The method of claim 17, further comprising allowing a user to control data transformation using a configuration tool.

23. The method of claim 22, further comprising allowing the user to define, approve, and implement a data transformation process using the configuration tool.

24. A system for disguising and de-identifying data comprising:
an input data set containing confidential information;
a plurality of data transformation algorithms for removing confidential information from the input data set; and
a driver program for invoking the plurality of data transformation algorithms on the input data set and producing an output data set having no confidential information,
wherein data in the output data set is structurally similar to data in the input set and contains no confidential information.

25. The system of claim 24, further comprising a lookup table utilized by the data transformation algorithm for substituting confidential information in the input data set with non-confidential information.

26. The system of claim 25, wherein the lookup table comprises a first name lookup table, a last name lookup table, a company name lookup table, an address lookup table, or an ISP name lookup table.

27. The system of claim 24, wherein the input data set comprises a secure data set in a production environment.

28. The system of claim 24, wherein the plurality of data transformation algorithms comprises a first name transformation algorithm.

29. The system of claim 24, wherein the plurality of data transformation algorithm comprises a last name transformation algorithm.

30. The system of claim 24, wherein the plurality of data transformation algorithms comprises a company name transformation algorithm.

31. The system of claim 24, wherein the plurality of data transformation algorithms comprises a telephone number transformation algorithm.

32. The system of claim 24, wherein the plurality of data transformation algorithms comprises an address transformation algorithm.

33. The system of claim 24, wherein the plurality of data transformation algorithms comprises a social security number transformation algorithm.

34. The system of claim 24, wherein the plurality of data transformation algorithms comprises an e-mail address transformation algorithm.

35. The system of claim 24, wherein the plurality of data transformation algorithms transforms logically-similar input values of the input data set to a single output value for storage in the output data set.

36. The system of claim 24, wherein the plurality of data transformation algorithms transforms a given input value to a same output value for initial and subsequent transformations.

37. The system of claim 24, further comprising a second lookup table utilized by the data transformation algorithm for substituting confidential information in the input data set with non-confidential information.

38. The system of claim 37, wherein the second lookup table comprises a first name lookup table, a last name lookup table, a company name lookup table, an address lookup table, or an ISP name lookup table.

39. A method for disguising and de-identifying confidential information comprising:
retrieving an input value from an input data set;
determining a data type of the input value;
applying a transformation algorithm to the input value based upon the type of the input value to produce an output value having no confidential information; and
storing the output value in an output dataset.

40. The system of claim 39, wherein subsequent transformations of the input value produce the same output value.

41. The method of claim 39, further comprising retrieving and transforming additional input values from the input data set to produce output values having no confidential information.

42. The method of claim 39, further comprising:
determining whether the input value corresponds to an invalid value; and
preserving the input value if the input value corresponds to the invalid value.

43. The method of claim 42, wherein the step of preserving the input value comprises:
preventing transformation of the input value; and
setting the output value to the input value.

44. The method of claim 39, wherein the step of applying the transformation algorithm comprises applying a first name transformation algorithm to the input value to produce an output value having a new first name, the new first name being free of confidential information.

45. The method of claim 39, wherein the step of applying the transformation algorithm comprises applying a last name transformation algorithm to the input value to produce an output value having a new last name, the new last name being free of confidential information.

46. The method of claim 39, wherein the step of applying the transformation algorithm comprises applying a company name transformation algorithm to the input value to produce an output value having a new company name, the new company name being free of confidential information.

47. The method of claim 39, wherein the step of applying the transformation algorithm comprises applying an address transformation algorithm to the input value to produce an output value having a new address, the new address being free of confidential information.

48. The method of claim 39, wherein the step of applying the transformation algorithm comprises applying a telephone number transformation algorithm to the input value to produce an output value having a new telephone number, the new telephone number being free of confidential information.

49. The method of claim 39, wherein the step of applying the transformation algorithm comprises applying a social security number transformation algorithm to the input value to produce an output value having a new social security number, the new social security number being free of confidential information.

50. The method of claim 39, wherein the step of applying the transformation algorithm comprises applying an e-mail address transformation algorithm to the input value to produce an output value having a new e-mail address, the new e-mail address being free of confidential information.
